(19) United States
(12) Patent Application Publication
(10) Pub. No.: US 2024/0361476 A1
(43) Pub. Date: Oct. 31, 2024

(54) SCALABLE PHOTON DETECTOR

(71) Applicant: Idea Sistemas Eletronicôs LTDA S.A., Campinas (BR)

(72) Inventors: Marcio Colazza ARGENTATO, Campinas (BR); Victor KAYE, Campinas (BR); Renato APARECIDO NEGRÃO DE OLIVEIRA, Campinas (BR); Pietro Pereira BERTUZZO, Campinas (BR); Guilherme PAULINO, Campinas (BR); Juliano RODRIGUES FERNANDES DE OLIVEIRA, Campinas (BR); Julio César RODRIGUES FERNANDES DE OLIVEIRA, Dallas, TX (US)

(21) Appl. No.: 18/478,697

(22) Filed: Sep. 29, 2023

Related U.S. Application Data
(60) Provisional application No. 63/498,411, filed on Apr. 26, 2023.

(51) Int. Cl. G01T 1/24

(52) U.S. Cl. CPC G01T 1/243; G01T 1/244; G01T 1/247

(57) ABSTRACT

In some implementations, a photon detector includes a detector module that includes a detector unit. The detector unit may include a sensor device including a sensor layer, and a plurality of detector devices, connected to the sensor layer, configured to convert electrical signals to digital signals based on photon counting. The detector unit may include a readout component communicatively connected to the sensor device. The readout component may include a data conversion device configured to convert the digital signals into formatted data and to output a plurality of channels, of the formatted data, corresponding to a respective one of the plurality of detector devices. The readout component may include a transceiver configured to transmit the plurality of channels of the formatted data. The detector module may include a management component communicatively connected to the detector unit and configured to provide power and control signals to the readout component.

### CROSS-REFERENCE TO RELATED APPLICATION

This patent application claims priority to U.S. Provisional Patent Application No. 63/498,411, filed on Apr. 26, 2023, and entitled “SCALABLE X-RAY PHOTON COUNTING DETECTOR.” The disclosure of the prior application is considered part of and is incorporated by reference into this patent application.

### TECHNICAL FIELD

The present disclosure relates generally to photon detectors and to a scalable photon detector.

### BACKGROUND

A photon detector detects and converts light photons into electrical signals, which can be used to create digital images. One example of a photon detector is an x-ray photon detector. X-ray photon detectors can be classified as indirect conversion detectors and direct conversion detectors. In an indirect conversion detector, x-ray photons first interact with a scintillator layer that absorbs x-ray photons and emits light photons in response. The emitted light photons are then detected and converted into electrical signals by an array of photodetectors. In a direct conversion detector, x-ray photons interacting with a semiconductor layer are directly converted into electrical signals (e.g., without the use of a scintillator). Specifically, x-ray photons interacting with the semiconductor layer cause ionization and generate electron-hole pairs. The electron-hole pairs are collected by an electric field to generate an electrical signal. In general, direct conversion can produce higher-quality x-ray images relative to indirect conversion.

### SUMMARY

In some implementations, a photon detector includes a detector module. The detector module may include a detector unit. The detector unit may include a sensor device including a sensor layer having an array of sensor pixels configured to generate electrical signals responsive to light radiation incident on the sensor layer, and a plurality of detector devices connected to the sensor layer. Each of the plurality of detector devices may include an array of detector elements configured to convert the electrical signals to digital signals based on photon counting. The detector unit may include a readout component communicatively connected to the sensor device. The readout component may include a data conversion device configured to convert the digital signals into formatted data and to output a plurality of channels of the formatted data. Each of the plurality of channels may correspond to a respective one of the plurality of detector devices. The readout component may include a transceiver communicatively connected to the data conversion device and configured to transmit the plurality of channels of the formatted data. The detector module may include a management component communicatively connected to the detector unit and configured to provide power and control signals to the readout component.

In some implementations, a detector module includes an optical head including one or more sensor devices. Each of the one or more sensor devices may include a sensor layer having an array of sensor pixels configured to generate electrical signals responsive to light radiation incident on the sensor layer, and a plurality of detector devices connected to the sensor layer. Each of the plurality of detector devices may include an array of detector elements configured to convert the electrical signals to digital signals based on photon counting. The detector module may include an electronics stack including one or more readout circuit boards, communicatively connected to the one or more sensor devices, configured to transmit formatted data based on the digital signals. The detector module may include a management circuit board, in a stacked configuration with the one or more readout circuit boards, configured to provide power and control signals to the one or more readout circuit boards. The detector module may include a cooling system. The cooling system may include a heat exchanger, where the electronics stack is between the optical head and the heat exchanger. The cooling system may include one or more first heat spreaders respectively contacting the one or more sensor devices. The cooling system may include one or more first heat pipes extending respectively from the one or more first heat spreaders to the heat exchanger. The cooling system may include one or more second heat spreaders interleaved with the electronics stack. The cooling system may include one or more second heat pipes extending respectively from the one or more second heat spreaders to the heat exchanger.

In some implementations, an x-ray detector module includes an x-ray detector unit. The x-ray detector unit may include a sensor device configured to provide x-ray direct conversion. The sensor device may include a sensor layer having an array of sensor pixels configured to generate electrical signals responsive to x-ray radiation incident on the sensor layer, and a plurality of detector devices connected to the sensor layer. Each of the plurality of detector devices may include an array of detector elements configured to convert the electrical signals to digital signals based on photon counting. The x-ray detector unit may include a readout component communicatively connected to the sensor device. The readout component may include a data conversion device configured to convert the digital signals into formatted data and to output a plurality of channels of the formatted data. Each of the plurality of channels may correspond to a respective one of the plurality of detector devices. The readout component may include a transceiver communicatively connected to the data conversion device and configured to transmit the plurality of channels of the formatted data. The x-ray detector module may include a management component communicatively connected to the x-ray detector unit and configured to provide power and control signals to the readout component.

### BRIEF DESCRIPTION OF THE DRAWINGS

FIG. 1 is a diagram of an example detector unit.

FIG. 2 is a diagram of an example detector module.

FIG. 3 is a diagram of an example detector system.

FIG. 4 is a perspective view of an example detector module.

FIG. 5 is a partially exploded view and a cross-sectional view taken along line A-A of the example detector module of FIG. 4.

FIG. 6 is a diagram of example detectors.

### DETAILED DESCRIPTION

The following detailed description of example implementations refers to the accompanying drawings. The same reference numbers in different drawings may identify the same or similar elements.

As described above, a photon detector, such as an x-ray photon detector, can be used to detect and measure individual photons. A photon detector may include an optical head with one or more sensors that generate electrical signals in response to photons incident on the sensors. The photon detector may also include circuitry to read data out from the sensors and to transmit the data to a computing device for creation of a digital image. For example, an x-ray photon detector can be used to generate digital x-ray images.

Conventionally, direct conversion x-ray photon detectors that are complex and expensive have been used in particle accelerator applications (e.g., synchrotrons). However, there are emerging applications for direct conversion x-ray photon detectors, such as security scanning and inspection, materials analysis and inspection, medical applications, and mobile x-rays, among other examples, that would benefit from a simplified and more economical direct conversion x-ray photon detector. Moreover, each of these various applications may have different requirements for effective sensing area, energy range to be detected, and/or x-ray intensity to be detected, among other examples.

Generally, direct conversion x-ray photon detectors lack features facilitating modularization and scalability that would support such a wide range of applications. For example, a conventional direct conversion x-ray photon detector module may multiplex signals produced by multiple sensors into a single data stream to be processed and used to generate a digital image. Accordingly, the detector module may include complex and expensive circuitry components (e.g., field programmable gate arrays (FPGAs)) capable of receiving numerous data inputs in order to perform this multiplexing. Moreover, the detector module may include a high speed and expensive transceiver for transmitting the single data stream from the detector module for further processing. Furthermore, because data is read out from the detector module as a large, single data stream, increasing a sensor area by combining multiple detector modules into a single panel may reduce a frame rate and an overall performance.

Additionally, these complex and high-speed components may generate significant heat, which may necessitate the use of a large cooling system in the detector module. Conventionally, the cooling system may include one or more manifolds and multiple hoses to transport cooling fluid to a front of the detector module to provide direct cooling to an optical head of the detector module. A footprint of the cooling system may be much greater than an active sensor area of the detector module, thereby resulting in significant dead space surrounding the active sensor area. Accordingly, detector modules of this type may be unsuitable for combining into larger arrays due to the large gaps that would be present between active sensor areas (e.g., due to the dead space).

Some implementations described herein provide a photon detector module that has reduced complexity and a smaller form factor suitable for scalability and modularization. The photon detector module can be used alone, or multiple photon detector modules can be combined into a detector panel of virtually any size, thereby facilitating the use of the photon detector module in a range of applications. In some implementations, the photon detector module may provide direct conversion x-ray photon detection.

In some implementations, a detector module may include one or more detector units. A detector unit may include one or more sensor devices configured to convert light (e.g., x-ray) photons into electrical signals. A sensor device may include a sensor layer and a plurality of detector devices connected to the sensor layer. The sensor layer may include an array of sensor pixels configured to generate electrical signals responsive to light radiation incident on the sensor layer. Each of the detector devices may include an array of detector elements that are configured to convert the electrical signals of the sensor layer to digital signals based on photon counting.

In addition, the detector unit may include a readout component communicatively connected to the one or more sensor devices. The readout component may include one or more readout chains, each responsible for handling data of a respective sensor device of the detector unit. A readout chain may include a data conversion device and a transceiver. The data conversion device may be configured to receive and convert the digital signals output by its corresponding sensor device into formatted data. For example, the data conversion device may be configured to receive digital signals from multiple detector devices of the sensor device. Moreover, the data conversion device may be configured to output a plurality of channels of the formatted data, where each channel corresponds to a respective one of the detector devices. For example, rather than outputting a single stream of data that multiplexes the digital signals output by the detector devices, the data conversion device may output multiple channels, and each channel may be associated with digital signals output by a respective detector device. This enables simplification and cost reduction for the data conversion device. The transceiver may be configured to transmit (e.g., out from the readout component) the plurality of channels of the formatted data output by its corresponding data conversion device. That is, the transceiver may be dedicated for the data conversion device, and thus may support relatively low data rates, thereby reducing a complexity and a cost of the transceiver.

As described above, the detector module may include one or more detector units and a management component communicatively connected to the detector unit(s). The management component may be configured to provide power and control signals to each readout component of a detector unit. Separating power and control management (e.g., performed by the management component), and data communication (e.g., performed by a readout component), to different components of the detector module facilitates simplification of the management component and enables the use of a less powerful power supply.

In some implementations, the detector module may include a cooling system. The cooling system may include a heat exchanger, such as a water block, that is located at a back end of the detector module, opposite an optical head, including one or more sensor devices of the detector unit(s), that is located at a front end of the detector module 400. For example, an electronics stack (e.g., a stack of circuit boards), including one or more readout components and the management component, may be between the optical head and the heat exchanger.

The cooling system may include one or more first heat spreaders respectively contacting, or otherwise configured to transfer heat from, the one or more sensor devices in the optical head. Additionally, the cooling system may include one or more first heat pipes to transfer heat from the optical head (e.g., from the one or more first heat spreaders) to the heat exchanger. The cooling system may also include one or more second heat spreaders, interleaved between circuit boards in the electronics stack, respectively contacting, or otherwise configured to transfer heat from, the circuit boards of the electronics stack. Furthermore, the cooling system may include one or more second heat pipes to transfer heat from the electronics stack (e.g., from the one or more second heat spreaders) to the heat exchanger. By locating the heat exchanger at a back end of the detector module, and by using heat pipes to transfer heat from the optical head and the electronics stack to the heat exchanger, the cooling system may omit a manifold and associated hoses that otherwise would be used to distribute cooling fluid directly to the optical head. In this way, a footprint of the cooling system may be reduced significantly. Accordingly, an active sensor area of the detector module may cover a greater proportion of an overall size of the detector module, thereby reducing dead space around the active sensor area.

In some implementations, a photon detector may include one or multiple detector modules. For example, the photon detector may have an active sensor area corresponding to a sum of the active sensor areas of the multiple detector modules. Because a detector module does not multiplex the data of multiple sensor devices, detector modules can be grouped together and scaled in quantity without sacrificing frame rate. Moreover, by reducing dead space around an active sensor area by using the cooling system described herein, detector modules may be placed side by side with negligible gaps between active sensor areas of adjacent detector modules. In this way, the photon detector can be scaled to include any number of detector modules in many possible configurations.

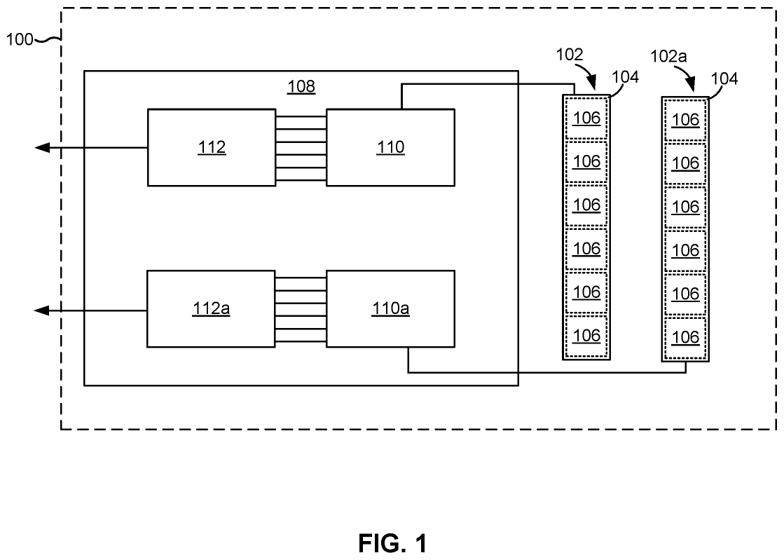

FIG. 1 is a diagram of an example detector unit 100. For example, the detector unit 100 may be an x-ray detector unit configured to detect photons at x-ray wavelengths. Additionally, or alternatively, the detector unit 100 may be configured to detect photons at other wavelengths, such as visible light wavelengths or infrared light wavelengths, among other examples.

The detector unit 100 includes a sensor device 102, which may be referred to as a “detector head.” The sensor device 102 may be configured to provide x-ray direct conversion. The sensor device 102 may convert light (e.g., x-ray) photons into electrical signals. In other words, the sensor device 102 may be configured to provide analog to digital conversion of light (e.g., x-ray) signals. The sensor device 102 may include a sensor layer 104 and a plurality of detector devices 106 connected to the sensor layer 104.

The sensor layer 104 may include an array of sensor pixels configured to generate electrical signals responsive to light (e.g., x-ray) radiation incident on the sensor layer 104. For example, light (e.g., x-ray) photons interacting with the sensor layer 104 may generate electron-hole pairs representing electrical signals. The sensor layer 104 may include a semiconductor material, such as amorphous selenium or cadmium telluride. The sensor layer 104 may include a continuous sheet that includes the array of sensor pixels, or multiple discrete sheets placed side-by-side that in combination provide the array of sensor pixels.

Each of the detector devices 106 may include an array of detector elements that are configured to convert the electrical signals of the sensor layer 104 to digital signals based on photon counting. For example, the photon counting may include incrementing a photon counter if a photon satisfies an energy discrimination level (e.g., thereby filtering out signals, such as background noise, that do not meet particular energy criteria). Accordingly, a detector element may include circuitry configured for photon counting, such as an amplifier (e.g., a charge-sensitive amplifier), a pulse shaper, a discriminator (or a comparator), and/or pulse processing circuitry (e.g., including counter circuitry). A detector device 106 may include an application specific integrated circuit (ASIC) or other circuitry configured to perform the functions of a detector device 106 described herein.

Each of the detector elements of the detector devices 106 may correspond to a respective sensor pixel of the sensor layer 104 to provide analog to digital conversion for that pixel (e.g., by photon counting). The sensor device 102 may define a single sensor or multiple sensors, depending on the quantity of detector devices 106 connected to the sensor layer 104 (e.g., a position of a detector device 106 with respect to the sensor layer 104 may define a location of a sensor). For example, the sensor device 102 may define from one to six sensors.

The detector unit 100 includes a readout component 108 communicatively connected to the sensor device 102 (e.g., to enable the exchange of information between the sensor device 102 and the readout component 108). The readout component 108 may include a circuit board (e.g., a printed circuit board (PCB)) that is communicatively connected to the sensor device 102 via an interface (e.g., a high-density interconnection). For example, the interface of the readout component 108 may be connected to the sensor device 102 via a flat flex connector or a flex PCB. The readout component 108 may be referred to as a “high-speed readout board.”

The readout component 108 may include a data conversion device 110 and a transceiver 112 communicatively connected to the data conversion device 110 (e.g., to enable the exchange of information between the data conversion device 110 and the transceiver 112). The data conversion device 110 may be configured to receive and convert the digital signals (e.g., the data) output by the sensor device 102 into formatted data. For example, the data conversion device 110 may encapsulate data based on the digital signals in accordance with a particular protocol so that the data can be used by the transceiver 112. The data conversion device 110 may be configured to receive digital signals from multiple detector devices 106 (e.g., up to six detector devices 106). For example, a quantity of inputs to the data conversion device 110 (e.g., six inputs) may not exceed a quantity of the multiple detector devices 106 of the sensor device 102, thereby reducing a complexity and a cost of the data conversion device 110. Moreover, the data conversion device 110 may be configured to output a plurality of channels of the formatted data, where each channel corresponds to a respective one of the detector devices 106. For example, rather than outputting a single stream of data that multiplexes the digital signals output by the detector devices 106, the data conversion device 110 may output multiple channels, and each channel may be associated with digital signals output by a respective detector device 106. Additionally, the data conversion device 110 may provide control data to the detector devices 106 of the sensor device 102. The data conversion device 110 may be a field programmable gate array (FPGA) or other circuitry configured to perform the functions of a data conversion device 110 described herein.

The transceiver 112 may be configured to transmit (e.g., out from the readout component 108) the plurality of channels of the formatted data output by the data conversion device 110. The transceiver 112 may have a small form factor pluggable (SFP) form factor. The transceiver 112 may be configured for data transmission and reception over a network, such as an Ethernet network. The transceiver 112 may be an optical transceiver or an electrical transceiver and may be wired or wireless. The transceiver 112 may be dedicated for communicating channels of the formatted data output by the data conversion device 110, but not for any other data conversion device 110 (as described below) of the readout component 108. In this way, the transceiver 112 may support relatively low data rates. For example, the data conversion device 110 and the transceiver 112 may support data rates up to 10 gigabits per second (Gbps), and/or only support data rates that are below 100 Gbps.

As shown, the detector unit 100 may include multiple sensor devices 102. For example, the detector unit 100 may include a first sensor device 102 and a second sensor device 102a. The first sensor device 102 and the second sensor device 102a may have the same configuration (e.g., the same quantity of sensors, the same sensor pixel density, or the like) or may be configured differently from each other. The readout component 108 may be communicatively connected to both the first sensor device 102 and the second sensor device 102a (e.g., via interfaces of the readout component 108, as described above). The readout component 108 may include respective readout chains for each sensor device 102. For example, for the first sensor device 102, the readout component 108 may include a first data conversion device 110 and a first transceiver 112. Continuing with the example, for the second sensor device 102a, the readout component 108 may include a second data conversion device 110a and a second transceiver 112a. Accordingly, the readout component 108 may be configured such that the first data conversion device 110 converts digital signals output by the first sensor device 102 into formatted data that is output to the first transceiver 112 for transmission from the readout component 108, and such that the second data conversion device 110a converts digital signals output by the second sensor device 102a into formatted data that is output to the second transceiver 112a for transmission from the readout component 108. In some implementations, the detector unit 100 may include more than two sensor devices 102 and corresponding readout chains of the readout component 108. By outputting data from the readout component 108 via multiple low-data-rate transceivers 112, rather than aggregating data and outputting the aggregated data via a single high-data-rate transceiver, the readout component 108 has reduced complexity and reduced cost (e.g., in a current state of the art, the cost of several 10 Gbps transceivers may be significantly less than the cost of a single 100 Gbps transceiver). For example, less expensive and less powerful FPGAs may be used by each readout component 108 outputting to a corresponding less expensive and low-data-rate transceiver 112 compared to a device with more expensive and more powerful FPGAs which aggregates data and transmits using high-data-rate transceivers.

The architecture of the detector unit 100 described herein facilitates simple and low-cost scalability. As shown in FIG. 1, the detector unit 100 includes a total of 12 sensors defined by 12 detector devices 106 (e.g., where each readout chain, including a data conversion device 110 and a transceiver 112, supports 6 sensors). As an example, adding from 1 to 6 additional sensors to the detector unit 100 would involve adding one additional readout chain used for the additional sensors. As described herein, a readout chain includes a low-cost data conversion device 110 (e.g., a less expensive and less powerful FPGA) and a low-cost transceiver 112 (e.g., a less expensive and low-data-rate transceiver). For example, because the detector unit 100 uses a relatively greater ratio of data conversion devices 110 to sensors (e.g., one data conversion device 110 for up to 6 sensors), less expensive data conversion devices 110 (e.g., FPGAs) may be used. Thus, the cost of adding several sensors to the detector unit 100 is in proportion to the relatively small expansion of the detector unit 100 provided by the additional sensors.

In contrast, a device using a more expensive and more powerful FPGA that aggregates data and transmits using a high-data-rate transceiver may be more difficult and expensive to scale. For example, if the FPGA of the device supports the aggregation of data for up to 12 sensors, then adding several additional sensors, in a similar manner as described above, would involve adding one additional expensive and powerful FPGA. For example, because the device uses a relatively lower ratio of FPGAs to sensors (e.g., one FPGA for up to 12 sensors), more expensive FPGAs are needed. Thus, the cost of adding several sensors to the device is not commensurate with the relatively small expansion of the device provided by the additional sensors.

As indicated above, FIG. 1 is provided as an example. Other examples may differ from what is described with regard to FIG. 1.

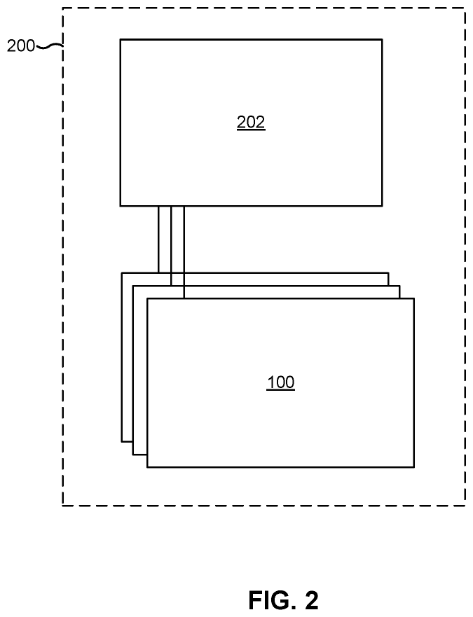

FIG. 2 is a diagram of an example detector module 200. For example, the detector module 200 may be an x-ray detector module configured to detect photons at x-ray wavelengths. Additionally, or alternatively, the detector module 200 may be configured to detect photons at other wavelengths, such as visible light wavelengths or infrared light wavelengths, among other examples.

The detector module 200 may include one or more detector units 100 and a management component 202 communicatively connected to the detector unit(s) 100. The management component 202 may be configured to provide power and control signals (e.g., for coordination and for configuring a frame rate, an acquire time, a trigger mode, an operational mode, or the like) to a readout component 108 of a detector unit 100. For example, the management component 202 may include a controller (e.g., a microcontroller) configured to provide power and control management for a detector unit 100. The management component 202 may include a circuit board (e.g., a PCB) that is communicatively connected to a readout component 108 of a detector unit 100. For example, the management component 202 and the readout component 108 may be connected via a flat flex connector or a flex PCB. The management component 202 may be referred to as a “power and control management board.” Separating power and control management (e.g., performed by the management component 202), and data communication (e.g., performed by a readout component 108), to different circuit boards facilitates simplification of the management component 202 and enables the use of a less powerful power supply.

As shown, the detector module 200 may include multiple detector units 100. For example, the multiple detector units 100 may be connected respectively to the management component 202, and the management component 202 may provide power and control signals to respective readout components 108 of the multiple detector units 100. For example, the management component 202 may provide coordination of the multiple detector units 100. In some implementations, in a select configuration, the detector module 200 may include the management component 202 and three detector units 100, each of which can support two sensor devices 102, and each sensor device 102 can support six detector devices 106. Thus, in the select configuration, the detector module 200 may include a total of 36 sensors. In the detector module 200, the sensor devices 102 may be arranged in rows, or in another suitable configuration. The sensor devices 102 of the multiple detector units 100 may define an optical head of the detector module 200.

As indicated above, FIG. 2 is provided as an example. Other examples may differ from what is described with regard to FIG. 2.

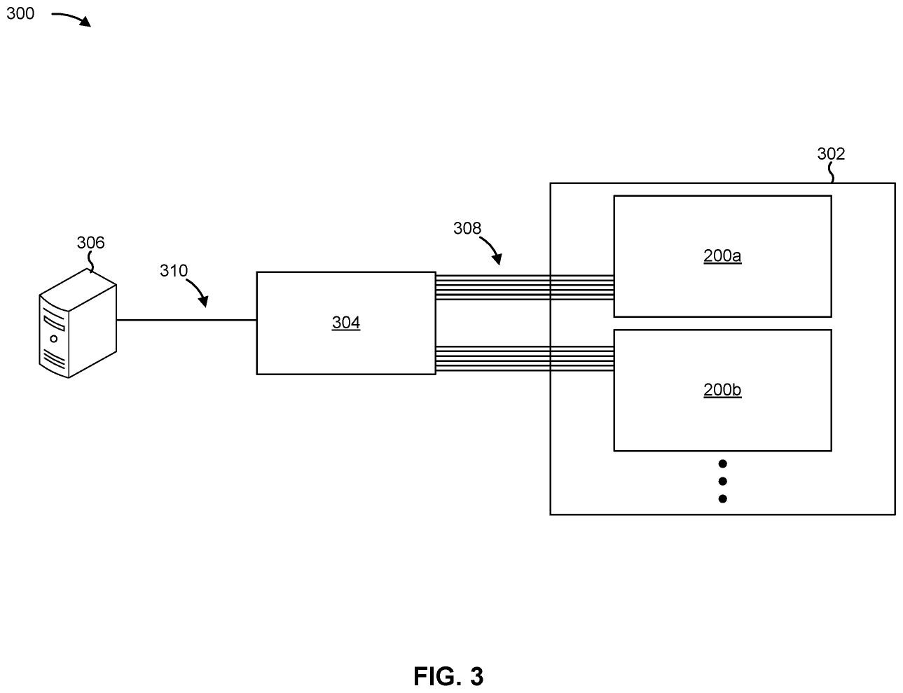

FIG. 3 is a diagram of an example detector system 300. For example, the detector system 300 may be an x-ray detector system configured to detect photons at x-ray wavelengths. Additionally, or alternatively, the detector system 300 may be configured to detect photons at other wavelengths, such as visible light wavelengths or infrared light wavelengths, among other examples.

The detector system 300 may include a detector 302. For example, the detector 302 may be an x-ray detector. The detector 302 may include one or more detector modules 200. For example, the detector 302 may include an m×n array of detector modules 200, where m and n are integers greater than or equal to 1 (and where m=n or m≠n). As an example, the detector 302 may include multiple detector modules 200, such as a first detector module 200a and a second detector module 200b, as shown. The detector 302 may have an active sensor area corresponding to a sum of the active sensor areas of the multiple detector modules 200 of the detector 302. The detector modules 200 of the detector 302 may be grouped together to form a sensor area in a square shape, a rectangular shape, a linear shape, or another suitable shape that may be used for a particular application. As described herein, because a detector module 200 does not multiplex the data of multiple sensor devices 102, detector modules 200 can be grouped together and scaled in quantity without sacrificing frame rate. An electrical or a physical connection between the detector modules 200 may facilitate synchronization of a trigger signal for activating the detector modules 200.

Additionally, the detector system 300 may include a network switch 304 (e.g., an optical switch, an Ethernet switch, or the like). For example, each of the transceivers 112 of the detector 302 may be configured to transmit a plurality of channels of formatted data, as described above, to the network switch 304. The network switch 304 may be configured to multiplex the plurality of channels transmitted by each transceiver 112 into aggregate data (e.g., a single data stream), and to output the aggregate data to a computing device 306 of the detector system 300. The computing device 306 may process the aggregate data to generate a digital image (e.g., a digital x-ray image) based on the aggregate data. The computing device 306 may also provide control commands for each of the management components 202 via the network switch 304. The computing device 306 may include one or more user devices (e.g., desktop computers, laptop computers, tablet computers, or the like), one or more servers, or the like.

In some implementations, the transceivers 112 and the network switch 304 may be optical and may be connected via optical fibers 308. For example, each transceiver 112 may convert data from electrical to optical domains and transmit to the network switch 304 via a respective optical fiber 308 (e.g., a quantity of optical fibers 308 to the network switch 304 corresponds to a quantity of transceivers 112). The connection of the transceivers 112 and the network switch 304 via the optical fibers 308 may support a data rate corresponding to the data rate supported by the transceivers 112. That is, the connection of the transceivers 112 and the network switch 304 via the optical fibers 308 may support relatively low data rates thereby enabling lower costs. For example, the connection of the transceivers 112 and the network switch 304 via the optical fibers 308 may support data rates up to 10 Gbps, and/or only support data rates that are below 100 Gbps. In some implementations, the network switch 304 and the computing device 306 may be connected via one or more optical fibers 310. The connection of the network switch 304 and the computing device 306 via the optical fiber(s) 310 may support a higher data rate than the data rate associated with the connection of the transceivers 112 and the network switch 304 via the optical fibers 308. For example, the connection of the network switch 304 and the computing device 306 via the optical fiber(s) 310 may support a data rate up to 100 Gbps or higher.

As indicated above, FIG. 3 is provided as an example. Other examples may differ from what is described with regard to FIG. 3.

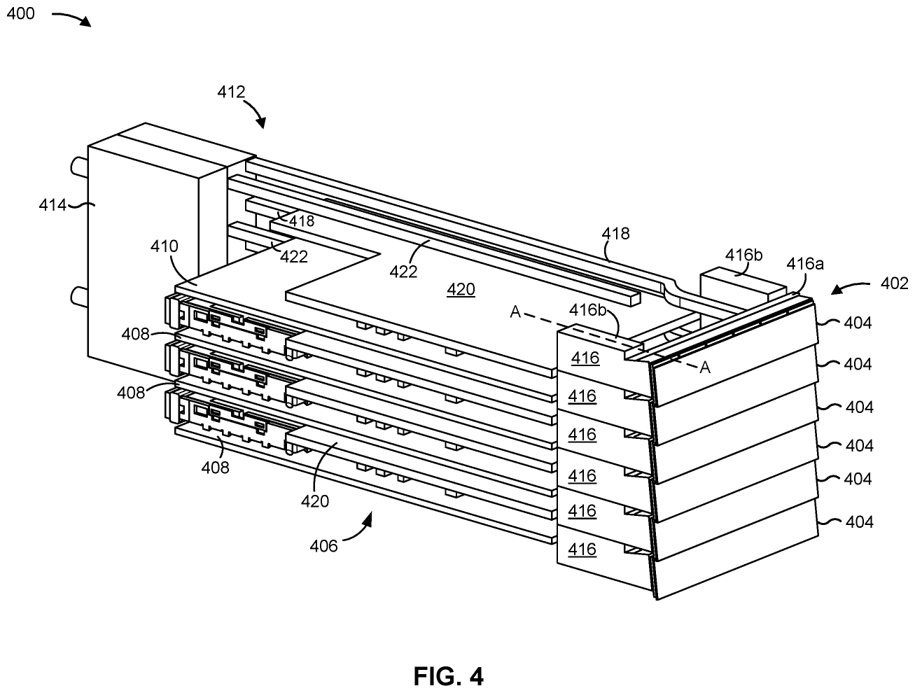

FIG. 4 is a perspective view of an example detector module 400. The detector module 400 may be based on the architecture of the detector module 200, described above.

The detector module 400 may have an optical head 402 that includes one or more sensor devices 404. A sensor device 404 may correspond to a sensor device 102, described above. The detector module 400 may include an electronics stack 406. The electronics stack 406 may include a management circuit board 410 in a stacked configuration with one or more readout circuit boards 408 (e.g., the management circuit board 410 and the one or more readout circuit boards 408 may be arranged in the electronics stack 406). A readout circuit board 408 may correspond to a readout component 108, described above. The management circuit board 410 may correspond to a management component 202, described above. As shown, the electronics stack 406 may include three readout circuit boards 408 connected to the management circuit board 410, in a similar manner as described in connection with FIG. 2.

The detector module 400 may include a cooling system 412. The cooling system 412 may include a heat exchanger 414. The heat exchanger 414 may be located at a back end of the detector module 400, opposite the optical head 402 that is located at a front end of the detector module 400. For example, the electronics stack 406 may be between the optical head 402 and the heat exchanger 414. The heat exchanger 414 may include a water block, an active heatsink (e.g., a fan-cooled heatsink), a passive heatsink, and/or a shell-and-tube heat exchanger, among other examples. In the example of the water block, the water block may include a fluid inlet, a fluid outlet, and a plurality of fins across which a fluid travels from the fluid inlet to the fluid outlet.

The cooling system 412 may include one or more first heat spreaders 416 (referred to herein as “head heat spreaders 416”) respectively contacting, or otherwise configured to transfer heat from, the one or more sensor devices 404. For example, the cooling system 412 may include multiple head heat spreaders 416 for respective sensor devices 404. That is, a quantity of the head heat spreaders 416 may correspond to a quantity of the sensor devices 404. In some implementations, a single head heat spreader 416 may contact or otherwise have a configuration to transfer heat from multiple sensor devices 404, or multiple head heat spreaders 416 may contact or otherwise have a configuration to transfer heat from a single sensor device 404.

The head heat spreaders 416 may be composed of a thermally conductive material (e.g., one or more metals, such as copper or aluminum). A head heat spreader 416 may include a plate (e.g., a strip) or a block formed into a generally U-shape. For example, the head heat spreader 416 may include a crossbar 416a and a pair of arms 416b extending from respective ends of the crossbar 416a. The crossbar 416a may extend along an inward side (i.e., opposite a sensing side associated with a sensor layer) of a sensor device 404. For example, the crossbar 416a may have a thermal connection to the detector devices (e.g., detector devices 106) of the sensor device 404. The arms 416b of the head heat spreader 416 may extend from the ends of the crossbar 416a towards the electronics stack 406. The crossbar 416a may be configured to provide a particular angling of the sensor device 404 when the sensor device 404 is attached to the crossbar 416a. The U-shape may structurally support the sensor device 404 without the use of additional supports or structural elements that may increase a size of the detector module 400. In some implementations, a head heat spreader 416 may include one or more indents or openings to facilitate routing of electrical connectors (e.g., flat flex connector(s) or flex PCB(s)) from the optical head 402 to the electronics stack 406.

The cooling system 412 may include one or more first heat pipes 418 (referred to herein as “head heat pipes 418”) to transfer heat from the optical head 402 (e.g., from the one or more head heat spreaders 416) to the heat exchanger 414. For example, the head heat pipes 418 may extend respectively from the head heat spreaders 416 to the heat exchanger 414. As an example, the cooling system 412 may include multiple head heat pipes 418 that extend from respective head heat spreaders 416. That is, a quantity of the head heat pipes 418 may correspond to a quantity of the sensor devices 404. A head heat pipe 418 may be connected to (e.g., thermally connected to) a head heat spreader 416. For example, a portion of the head heat pipe 418 may extend along at least a portion of the head heat spreader 416. As an example, the head heat pipe 418 may extend along a first arm 416b of the head heat spreader 416, the crossbar 416a of the head heat spreader 416, and/or a second arm 416b of the head heat spreader 416.

The cooling system 412 may include one or more second heat spreaders 420 (referred to herein as “stack heat spreaders 420”) interleaved in the electronics stack 406. The stack heat spreaders 420 may respectively contact, or otherwise have a configuration to transfer heat from, the circuit boards (e.g., the at least one readout circuit board 408 and the management circuit board 410) of the electronics stack 406. For example, the cooling system 412 may include multiple stack heat spreaders 420 for respective circuit boards of the electronics stack 406. That is, a quantity of the stack heat spreaders 420 may correspond to a total quantity of the one or more readout circuit boards 408 and the management circuit board 410 in the electronics stack 406. In some implementations, a single stack heat spreader 420 may contact, or otherwise have a configuration to transfer heat from, multiple circuit boards in the electronics stack 406.

The stack heat spreaders 420 may be composed of a thermally conductive material (e.g., one or more metals, such as copper or aluminum). A stack heat spreader 420 may include a plate, which may have a smaller footprint than a circuit board of the electronics stack 406. In some implementations, a stack heat spreader 420 may be in the shape of a rectangle that includes a corner cutout. The corner cutout may accommodate one or more transceivers (e.g., transceivers 112) of a readout circuit board 408. In some implementations, a stack heat spreader 420 may contact one or more cages, that hold transceivers, of a readout circuit board 408. Additionally, or alternatively, a stack heat spreader 420 may contact one or more head heat spreaders 416.

The cooling system 412 may include one or more second heat pipes 422 (referred to herein as “stack heat pipes 422”) to transfer heat from the electronics stack 206 (e.g., from the one or more stack heat spreaders 420) to the heat exchanger 414. For example, the stack heat pipes 422 may extend respectively from the stack heat spreaders 420 to the heat exchanger 414. As an example, the cooling system 412 may include multiple stack heat pipes 422 that extend from respective stack heat spreaders 420. That is, a quantity of the stack heat pipes 422 may correspond to a total quantity of the one or more readout circuit boards 408 and the management circuit board 410 in the electronics stack 406. A stack heat pipe 422 may be connected to (e.g., thermally connected to) a stack heat spreader 420. For example, a portion of the stack heat pipe 422 may extend along a surface of the stack heat spreader 420.

By locating the heat exchanger 414 at a back end of the detector module 400, and by using heat pipes 418, 422 to transfer heat from the optical head 402 and the electronics stack 406 to the heat exchanger 414, the cooling system 412 may omit a manifold and associated hoses that otherwise would be used to distribute cooling fluid to the various components of the detector module 400. In this way, a size of the detector module 400 may be reduced to more closely match an active sensor area of the detector module 400. For example, a footprint of the cooling system 412 may be within a box defined by the active sensor area of the detector module 400.

The detector module 400 is shown without a housing to provide a view of the internal components of the detector module 400. In practice, the detector module 400 may include a housing that encloses the electronics stack 406 and at least a portion of the cooling system 412, but leaves a sensor area (e.g., front faces of the sensor devices 404) of the optical head 402 exposed.

As indicated above, FIG. 4 is provided as an example. Other examples may differ from what is described with regard to FIG. 4.

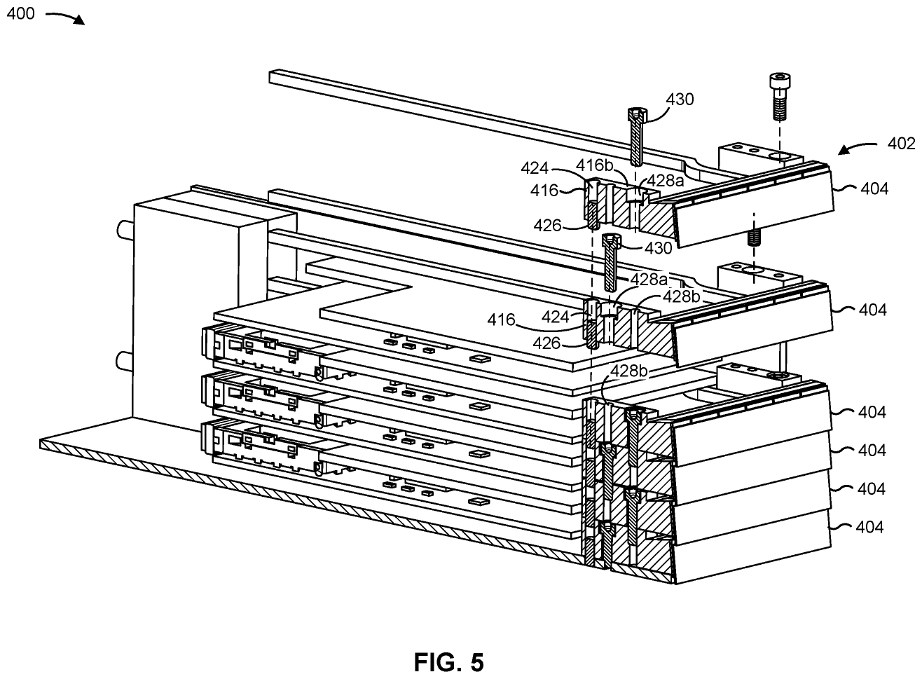

FIG. 5 is a partially exploded view and a cross-sectional view taken along line A-A of the example detector module 400 of FIG. 4.

As shown, multiple head heat spreaders 416 may be stacked. For example, the multiple head heat spreaders 416, each connected to a respective sensor device 404, may be stacked to form the optical head 402 of the detector module 400. As further shown, one or more arms 416b of a head heat spreader 416 may include one or more apertures 424 configured to receive pins 426. The pins 426 may align adjacent head heat spreaders 416 to provide an alignment of the sensor devices 404 used for proper imaging. For example, the apertures 424 of adjacent head heat spreaders 416 may align, so that a single pin 426 can be received in the respective apertures 424 of the adjacent head heat spreaders 416. Additionally, one or more arms 416b of the head heat spreader 416 may include one or more apertures 428 (shown as 428a and 428b) configured to receive fasteners 430. The fasteners 430 may mechanically connect adjacent heat spreaders 416. For example, the apertures 428 of adjacent head heat spreaders 416 may align, so that a single fastener 430 can be received in the respective apertures 428 of the adjacent head heat spreaders 416.

In some implementations, a heat spreader 416 may include two types of apertures 428 to receive fasteners 430. A first type, shown as an aperture 428a, may include a narrower lower section and a wider upper section (e.g., an aperture 428a having a larger diameter at the wider upper section than a diameter of the aperture 428a at the narrower lower section). The wider upper section may be configured to receive a head portion of a fastener 430, and the narrower lower section may be configured to receive a body portion (e.g., a threaded portion) of the fastener 430. A second type, shown as an aperture 428b, may be uniformly wide (e.g., may have a constant diameter corresponding to the diameter of the narrower lower section of an aperture 428a) to receive the body portion of a fastener 430. Accordingly, for a set of heat spreaders 416, including a top, a middle, and a bottom heat spreader 416 adjacent in a stack, a fastener 430, disposed in an aperture 428a of the middle heat spreader 416, may extend through the middle heat spreader 416 to an aperture 428b of the bottom heat spreader 416. Similarly, a fastener 430, disposed in an aperture 428a of the top heat spreader 416, may extend through the top heat spreader 416 to an aperture 428b of the middle heat spreader 416.

As indicated above, FIG. 5 is provided as an example. Other examples may differ from what is described with regard to FIG. 5.

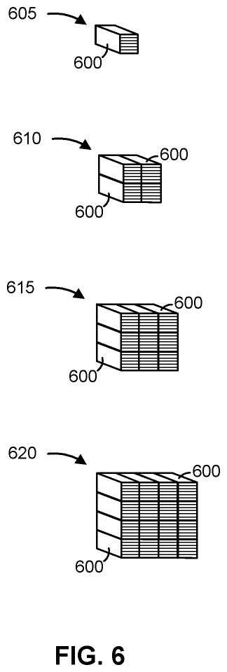

FIG. 6 is a diagram of example detectors 605, 610, 615, and 620. For example, the detectors 605, 610, 615, and 620 may be x-ray detectors configured to detect photons at x-ray wavelengths. Additionally, or alternatively, the detectors 605, 610, 615, and 620 may be configured to detect photons at other wavelengths, such as visible light wavelengths or infrared light wavelengths, among other examples. The detectors 605, 610, 615, and 620 each may include one or more detector modules 600. A detector module 600 may correspond to a detector module 400, or another detector module based on the architecture of the detector module 200, described above. As shown, the detector 605 may include a single detector module 600 (e.g., a 1×1 array), the detector 610 may include 4 detector modules 600 (e.g., a 2×2 array), the detector 615 may include 9 detector modules 600 (e.g., a 3×3 array), and the detector 620 may include 16 detector modules 600 (e.g., a 4×4 array). As described herein, a detector may be scaled to any number of detector modules 600 (e.g., an m×n array, where m and n are integers greater than or equal to 1, and where m=n or m≠n).

A total sensing area of a detector may be a combination of the individual sensing areas of the detector modules 600 in the detector. To facilitate scalability of a detector to any number of detector modules 600, gaps between respective sensing areas of detector modules 600 may be minimized. For example, an active sensor area of a detector module 600 may be at least 90% of an area of a cross-sectional minimum bounding box of the detector module 600. This may be achieved by using the cooling system 412, described herein.

As indicated above, FIG. 6 is provided as an example. Other examples may differ from what is described with regard to FIG. 6.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” “front,” “back,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A photon detector, comprising:
a detector module, comprising:
a detector unit, comprising:
a sensor device comprising:
a sensor layer comprising an array of sensor pixels configured to generate electrical signals responsive to light radiation incident on the sensor layer; and
a plurality of detector devices connected to the sensor layer,
wherein each of the plurality of detector devices comprises an array of detector elements configured to convert the electrical signals to digital signals based on photon counting;
a readout component communicatively connected to the sensor device, comprising:
a data conversion device configured to convert the digital signals into formatted data and to output a plurality of channels of the formatted data,
wherein each of the plurality of channels corresponds to a respective one of the plurality of detector devices; and
a transceiver communicatively connected to the data conversion device and configured to transmit the plurality of channels of the formatted data; and
a management component communicatively connected to the detector unit and configured to provide power and control signals to the readout component.

2. The photon detector of claim 1, wherein the transceiver is configured to transmit the plurality of channels of the formatted data to a network switch that is to multiplex the plurality of channels of the formatted data into aggregate data to be processed by a computing device.

3. The photon detector of claim 1, wherein the sensor device is a first sensor device,
wherein the detector unit further comprises a second sensor device, and
wherein the readout component is communicatively connected to the first sensor device and the second sensor device.

4. The photon detector of claim 3, wherein the data conversion device is a first data conversion device communicatively connected to the first sensor device, and the transceiver is a first transceiver communicatively connected to the first data conversion device, and
wherein the detector module further comprises a second data conversion device communicatively connected to the second sensor device and a second transceiver communicatively connected to the second data conversion device.

5. The photon detector of claim 4, wherein the detector unit is a first detector unit,
wherein the detector module further comprises a second detector unit, and
wherein the management component is communicatively connected to the first detector unit and the second detector unit.

6. The photon detector of claim 5, wherein the detector module is a first detector module, and
wherein the photon detector further comprises a second detector module.

7. A detector module, comprising:
an optical head comprising one or more sensor devices, each of the one or more sensor devices comprising:
a sensor layer comprising an array of sensor pixels configured to generate electrical signals responsive to light radiation incident on the sensor layer; and
a plurality of detector devices connected to the sensor layer,
wherein each of the plurality of detector devices comprises an array of detector elements configured to convert the electrical signals to digital signals based on photon counting;
an electronics stack comprising:
one or more readout circuit boards, communicatively connected to the one or more sensor devices, configured to transmit formatted data based on the digital signals; and
a management circuit board, in a stacked configuration with the one or more readout circuit boards, configured to provide power and control signals to the one or more readout circuit boards; and
a cooling system, comprising:
a heat exchanger,
wherein the electronics stack is between the optical head and the heat exchanger;
one or more first heat spreaders respectively contacting the one or more sensor devices;
one or more first heat pipes extending respectively from the one or more first heat spreaders to the heat exchanger;
one or more second heat spreaders interleaved with the electronics stack; and
one or more second heat pipes extending respectively from the one or more second heat spreaders to the heat exchanger.

8. The detector module of claim 7, wherein the heat exchanger is a water block.

9. The detector module of claim 7, wherein a quantity of the one or more second heat spreaders or the one or more second heat pipes is equal to a total quantity of the one or more readout circuit boards and the management circuit board.

10. The detector module of claim 7, wherein each of the one or more first heat spreaders comprises a crossbar extending along a sensor device and a pair of arms extending from respective ends of the crossbar toward the electronics stack.

11. The detector module of claim 10, wherein the one or more first heat spreaders comprise multiple heat spreaders that are stacked.

12. The detector module of claim 11, wherein the pair of arms include apertures to receive fasteners to mechanically connect adjacent heat spreaders of the one or more first heat spreaders.

13. The detector module of claim 11, wherein the pair of arms include apertures to receive pins to align adjacent heat spreaders of the one or more first heat spreaders.

14. The detector module of claim 7, further comprising:
a housing that encloses at least the electronics stack.

15. The detector module of claim 7, wherein an active sensor area of the detector module is at least 90% of an area of a cross-sectional minimum bounding box of the detector module.

16. An x-ray detector module, comprising:
an x-ray detector unit, comprising:
a sensor device configured to provide x-ray direct conversion, the sensor device comprising:
a sensor layer comprising an array of sensor pixels configured to generate electrical signals responsive to x-ray radiation incident on the sensor layer; and
a plurality of detector devices connected to the sensor layer,
wherein each of the plurality of detector devices comprises an array of detector elements configured to convert the electrical signals to digital signals based on photon counting;
a readout component communicatively connected to the sensor device, comprising:
a data conversion device configured to convert the digital signals into formatted data and to output a plurality of channels of the formatted data,
wherein each of the plurality of channels corresponds to a respective one of the plurality of detector devices; and
a transceiver communicatively connected to the data conversion device and configured to transmit the plurality of channels of the formatted data; and
a management component communicatively connected to the x-ray detector unit and configured to provide power and control signals to the readout component.

17. The x-ray detector module of claim 16, wherein the sensor device is a first sensor device,
wherein the x-ray detector unit further comprises a second sensor device, and
wherein the readout component is communicatively connected to the first sensor device and the second sensor device.

18. The x-ray detector module of claim 17, wherein the data conversion device is a first data conversion device communicatively connected to the first sensor device, and the transceiver is a first transceiver communicatively connected to the first data conversion device, and
wherein the x-ray detector module further comprises a second data conversion device communicatively connected to the second sensor device and a second transceiver communicatively connected to the second data conversion device.

19. The x-ray detector module of claim 16, wherein the x-ray detector unit is a first x-ray detector unit,
wherein the x-ray detector module further comprises a second x-ray detector unit, and
wherein the management component is communicatively connected to the first x-ray detector unit and the second x-ray detector unit.

20. The x-ray detector module of claim 16, wherein the readout component and the management component are arranged in an electronics stack,
wherein the sensor device is included in an optical head, and
wherein the x-ray detector module further comprises a cooling system, comprising:
a heat exchanger,
wherein the electronics stack is between the optical head and the heat exchanger; and
a plurality of heat pipes configured to transfer heat from the optical head and the electronics stack to the heat exchanger.
